(19) United States
(12) Patent Application Publication
(10) Pub. No.: US 2010/0231007 A1
(43) Pub. Date: Sep. 16, 2010

(54) Sunroof Reinforcement Assembly

(75) Inventors: Mike James Freeman, Allen Park, MI (US); Scott McKnight, Pinckney, MI (US)

Correspondence Address: Kristy J. Downing, Esq., 39555 Orchard Hill Pl., 6th Fl., PMB No.: 6051, Novi, MI, 48375, US

(73) Assignee: Ford Global Technologies LLC

(21) Appl. No.: 12/567,598

(22) Filed: Sep. 25, 2009

Related U.S. Application Data
(60) Provisional application No. 61/160,264, filed on Mar. 13, 2009.

(51) Int. Cl. B60J 7/00; B21D 53/88

(52) U.S. Cl. 296/210; 29/897.2

(57) ABSTRACT

The present disclosure relates to a roof structure for a vehicle having a sunroof (or moonroof). The roof structure includes a reinforcement assembly, or ring, that has several rails designed to encircle a sunroof opening. The rails can be spot welded together. Methods of manufacturing the reinforcement assemblies are also discussed.

### CROSS-REFERENCE TO RELATED APPLICATIONS

This application is a continuation and claims the benefit of U.S. Provisional Patent Ser. No. 61/160,264 titled “Sunroof Reinforcement Assembly” filed Mar. 13, 2009, which is hereby incorporated by reference in its entirety.

### TECHNICAL FIELD

The present disclosure relates to assembly and manufacturing techniques for vehicle sunroofs, more specifically, the present teachings relate to a sunroof reinforcement assembly as well as methods for manufacturing the same.

### BACKGROUND

Some contemporary automobiles include a sunroof or moonroof that consists of an opening in the vehicle roof. The moonroof usually has a sliding metal or glass door that selectively opens and closes the opening. This opening in the roof can demand additional structural reinforcement in the roof structure to meet the stiffness and stability requirements for the roof. Moreover the sunroof module can include heavy components such as electric motors, sunroof housing and sunroof door. Reinforcements are needed in the vehicle roof to support these features.

Current structural reinforcement members for moonroofs include rings that are formed from a sheet of metal. The reinforcements normally are cut or stamped as a unitary piece or ring for dimensional stability and to preclude wind and/or water leaks within the moonroof assembly. With this design the material utilization of moonroof reinforcement rings are typically very poor (e.g., between 25% and 40%). There can be significant costs associated with scrapping or recycling materials for re-use.

U.S. Patent Application No. 2007/0228777 titled “Roof Inner Body Structure” teaches a roof structure with a tailor-welded blank inner roof frame having a plurality of reinforced roof rails. This configuration includes an intermediate roof rail having a first material thickness and then the plurality of reinforced roof rails extending away from the intermediate roof rail. While this design can improve the overall structural rigidity of the assembly, the structure is incompatible with vehicle roofs having a sun/moonroof since it requires an intermediate rail commonly attached to all of the reinforcement rails. Moreover, it appears that this design would provide low material utilization as the '777 Application teaches manufacturing the roof structure from either separate stampings or one stamping. Paragraph [0024]. In either mode of stamping, unformed material edges would be scrapped.

Therefore, it is desirable to have a sunroof reinforcement assembly with improved material utilization characteristics.

### SUMMARY

The present invention may address one or more of the above-mentioned issues. Other features and/or advantages may become apparent from the description which follows.

Some embodiments of the present invention provide, for example, a method of manufacturing a reinforcement assembly for a vehicle sunroof. The method includes the steps of cutting a sheet of metal into four rails; positioning each of the rails to define an orifice greater than or equal to the size of a sunroof opening; and fixedly attaching the rails using a lap-joint configuration.

Certain embodiments of the present invention provide a roof structure for a vehicle having a sunroof that includes: a reinforcement assembly having a first rail attached to a second rail and third rail in a lap-joint configuration; and a fourth rail attached to the second rail and third rail in a lap-joint configuration. The reinforcement assembly defines an orifice that is greater than or equal to the size of a sunroof opening.

The present teachings provide a host of advantages. First, because the sunroof reinforcement assembly is a tailored spot-welded blank the assembly has better material utilization characteristics than conventional roof structures. In some embodiments the material utilization is approximately 80%-90%. Accordingly, there is no scrap-buy-back required.

Moreover, since spot welding is much cheaper than laser welding, the present teachings provide other significant cost savings. The savings can be, e.g., seven to sixteen cents per weld depending on the process utilized. Laser welding can also present lower material utilization characteristics as material is often removed from the flush surfaces of two adjoining pieces to accommodate the butt-joint required for a solid laser weld. Lap-joint laser welds may produce greater material utilization; still, laser welds are a more expensive option than spot welds. Spot welding can generally be done in a standard manufacturing facility and does not have to be outsourced to a specialty welder; however, laser welding is often outsourced, parts and materials are shipped to an external facility, there are added administrative costs. Laser welding presents several burdens; however, the present reinforcement assembly can be manufactured internally. In fact, many sunroof manufacturing facilities have spot welding processes for roof assemblies and structural members on site.

The present sunroof reinforcement assembly is not a “patch” welded or mash-seam blank reinforcement; it is a tailored spot-welded blank. Since the blank is not cut from a die no blank-die is required. This can also present a substantial cost savings.

The weld blank for the reinforcement assembly is tailored to meet the specifications of the roof structure. In one embodiment, the rear roof rail can be of a higher strength for safety, and the side roof rails can be of mild steel of lower gauges for further cost savings. It is possible to “doubled-up” metal in corners to preclude typically higher stresses.

The welding fixture is completely flexible. One can tailor gauges & grades for the weld guns. Once the fixture is constructed, the weld guns can be configured to slide to accommodate reinforcement assemblies of any size/length. Moreover, gauges can be easily changed locally during model-year freshenings (or change over). Other factors can drive changes to the welding fixture, e.g., a running change may be required such as a 1-touch-open needing higher gauge, or increased safety may call for higher strength. Such revisions are simpler to implement with the flexible welding fixture used to manufacture the reinforcement assembly.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

The invention will be explained in greater detail below by way of example with reference to the figures, in which the same references numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is a perspective view of a vehicle having a sunroof.

FIG. 2a illustrates top views of conventional sunroof reinforcement structures cut from a coil of sheet metal.

FIG. 2b illustrates top views of sunroof reinforcement structure rails, according to an exemplary embodiment of the present invention, cut from a coil of sheet metal.

FIG. 3 is a flow chart illustrating a purchasing-shipping-manufacturing model for a reinforcement assembly according to an exemplary embodiment of the present invention.

FIG. 4 is a top view of a vehicle roof structure having a reinforcement assembly according to one exemplary embodiment of the present invention.

FIG. 5 is a top view of a reinforcement assembly according to another exemplary embodiment of the present invention.

FIG. 6 is a top view of vehicle roof having multiple sun roofs openings.

FIG. 7 is a top view of a reinforcement assembly configured for use with the vehicle roof of FIG. 6.

FIG. 8 is a top view of another reinforcement assembly having longitudinal beads formed therein.

FIG. 9 is a perspective view of the reinforcement assembly of FIG. 8.

FIG. 10 is a cross-sectional view of the reinforcement assembly of FIG. 8.

FIG. 11a is a top view of a welding apparatus for use with an exemplary sunroof reinforcement assembly.

FIG. 11b is a top view of the welding apparatus of FIG. 11a configured for use with another exemplary sunroof reinforcement assembly.

FIG. 12 illustrates a method of manufacturing a reinforcement assembly according to an exemplary embodiment of the present invention.

### DETAILED DESCRIPTION

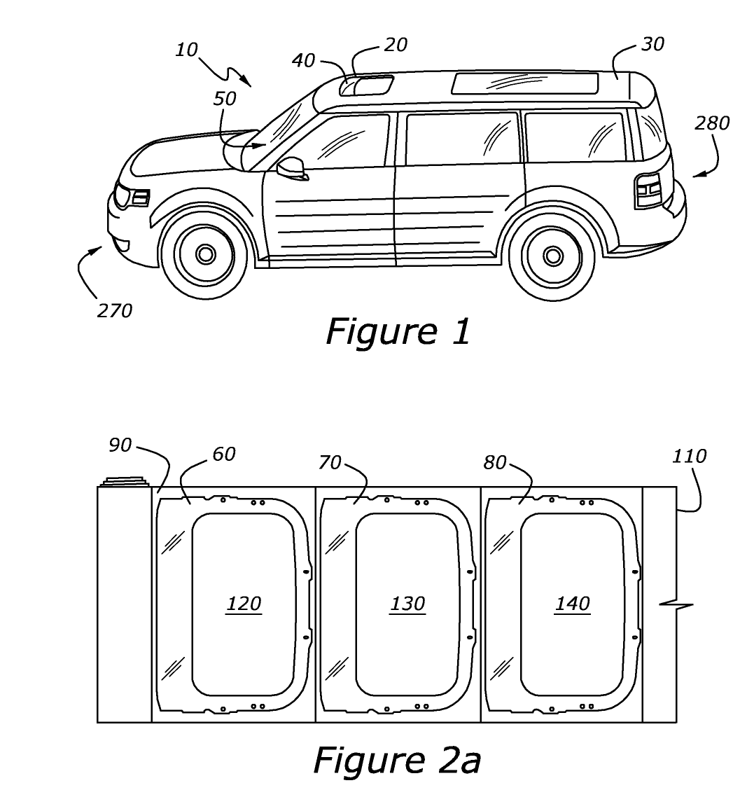

Referring to the drawings, FIGS. 1 and 2b-12, wherein like characters represent the same or corresponding parts throughout the several views there is shown examples of a sunroof reinforcement assembly for use with an automobile or vehicle having a sun/moonroof. The disclosed sunroof reinforcement assemblies are intended to add additional structural support to a vehicle roof structure having an orifice therein for the sunroof. While many vehicle sunroofs include a single orifice in the roof, some vehicle roofs can include multiple orifices or flexible orifices that can open in stages. For example, cross-over vehicles, sports utility vehicles and limousines can include multiple sunroofs and sunroofs of atypical orientations. The provided sunroof reinforcement assemblies substantially increase material utilization as the sunroof reinforcement rails are formed from a coil sheet of material, cut along its sheer. Conventional sunroof reinforcement assemblies that are stamped in one operation typically have material utilization rates of approximately 30%—due to the sunroof orifice formed in the middle of the assembly. With the tailored spot-welded blank material utilization can be as high as 80%-90%. Additionally, since the disclosed sunroof reinforcement assemblies are composed of a tailor welded blank, the assemblies can be constructed to be compatible with various sunroof designs including, but not limited to, those sunroofs discussed herein.

Referring now to FIG. 1, a perspective view of a vehicle 10 is shown. Vehicle 10 is a four-door cross-over automobile or all utility vehicle with an orifice 20 (or opening) in a roof 30 of the vehicle 10. Roof 30 includes a retractable cover 40 (e.g., a sun- or moon-roof) that selectively extends across the orifice 20 in the roof 30 to enclose a vehicle interior 50 where occupants can be seated. Cover 40 can be manually or electronically controlled. Although the illustrated vehicle 10 is depicted as a small car, vehicle can be any type of transportation device including large cars, sedans, convertibles, trucks, vans, minivans, SUVs, and limousines.

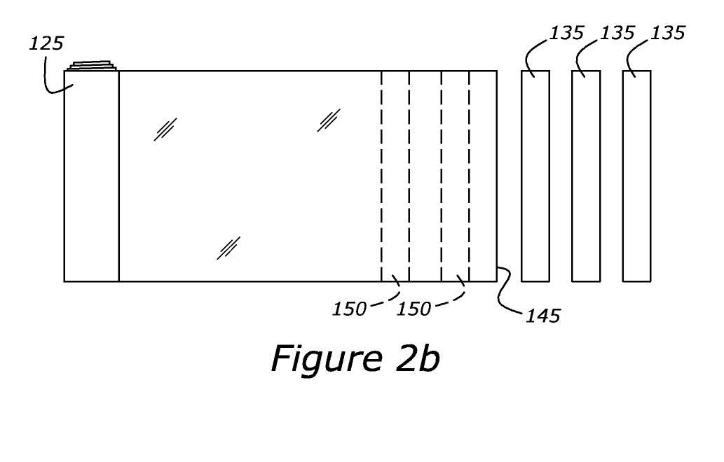

With reference now to FIG. 2a, there are shown therein top views of conventional sunroof reinforcement structures 60, 70, 80. Three rectangular reinforcement structures 60, 70, 80 are shown atop a coil sheet 90 of metal from which the structures can be formed. Structures 60, 70, 80 form a ring consisting of four members. The ring is a uniform member. Reinforcement structures 60, 70, 80 are configured to encircle a sunroof opening (e.g., 20 as shown in FIG. 1) in a vehicle roof. In the shown embodiment, each reinforcement structure 60, 70, 80 is approximately 1053 mm in width (or pitch), 724 mm long and 1 mm thick. The perimeter of each unit is approximately 5471 mm and the surface area of the reinforcement structures is 265190 mm². Reinforcement structures 60, 70, 80 have an angle degree of 179. The net weight for each reinforcement structure is 3 kg. The gross weight, however, is 8 kg. Reinforcement structures 60, 70, 80 are composed of a smoothed aluminum alloy. In the shown embodiment, CRDQ (or cold rolled draw quality) material is used. Reinforcement structures 60, 70, 80 can be composed of any material such as, e.g., titanium, steel or other metals and hard plastics.

FIG. 2a further shows the manner in which conventional reinforcement structures 60, 70, 80 are manufactured. Conventional reinforcement structures 60, 70, 80 are ring-shaped members that are form cut out from the long coil of sheet metal 90. A blank-die (not shown) makes one reinforcement structure at a time. The distance between each structure's blank is approximately 40 mm. The distance from the coil's edge 110 to the subsequent structure/blank is 40 mm. The unused material must be scrapped or recycled. The material in the inner circle of the structures 120, 130, 140 will also be scrapped or recycled. Form cut members are then stamped into shape before being attached to a vehicle roof structure. Due to this method of manufacturing the reinforcement structures 60, 70, 80 the engineering fall or material waste is 65%. Accordingly, with conventional reinforcement structures 60, 70, 80 more than half of the material used is scraped and material utilization is 35%.

Referring to FIG. 2b a different method of manufacturing the sunroof reinforcement assembly—according to the present invention—is shown. A coil sheet 125 is utilized and roof rails 135 are cut off the sheer from the coil sheet. In the shown embodiment, the rails 135 are of a substantially similar width and construction. Rails 135 have been cut from one end 145 of the coil sheet 125. Other rails, e.g., 150, can be formed from the end 145 of the sheet 125. After being cut from the coil sheet 125 the rails 135 are assembled to define a hole larger than the orifice in the sunroof (e.g., 20 as shown in FIG. 1). In this way all of the material from the coil sheet 125 is utilized in the sunroof reinforcement assembly. Thus the invention provides significantly greater material utilization than conventional reinforcement assemblies.

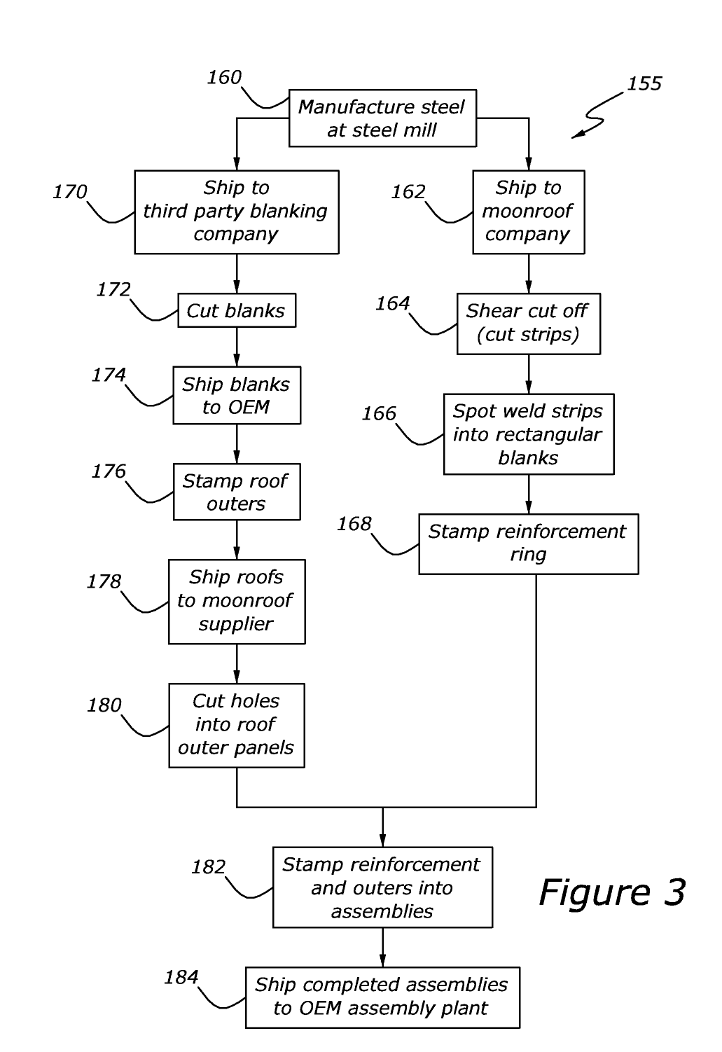

FIG. 3 further highlights the efficiencies inherent in the improved method of manufacturing the sunroof reinforcement assembly. Shown in FIG. 3 is flow chart 155 illustrating a purchasing-shipping-manufacturing model for a reinforcement assembly according to an exemplary embodiment of the present invention. The manufacturing process begins with processing the steel at a steel mill at 160. The steel is formed into sheets of a predetermined thickness wound into coils. The thickness comports with the thickness of the roof rails used in the sunroof reinforcement assembly. In one embodiment, the thickness of other members of the roof structure and the sunroof reinforcement assembly are the same and can utilize a coil sheet sharing the same material thickness. Under such circumstances the overall pricing of the steel purchased from an outside steel mill can be minimized due to purchase uniformity.

The sunroof reinforcement structure utilizes material from the steel mill. At step 162 the steel is shipped to an outside sun/moonroof manufacturing company. That company cuts the strips (or reinforcement rails) from the coil sheet 164 (e.g., as shown with respect to FIG. 2b). At step 166 the strips are formed into a tailored spot-welded blank. The blank is formed into a rectangular shape having an orifice defined therein. The reinforcement assembly includes a first rail attached to a second rail and a third rail; and a fourth rail attached to the second rail and the third rail. The reinforcement assembly defines an orifice that is greater than or equal to the size of a sunroof opening. In a final process, at 168, the reinforcement ring is stamped.

In a different process, that is shown occurring contemporaneously with the manufacture of the sunroof reinforcement assembly, the vehicle roof is manufactured. The roof is manufactured using materials from the steel mill as well. Those materials are shipped to a third party blanking company, at 170. Blanks are cut from the steel. Blanks can provide the primary structural support for the roof assembly. In the shown embodiment, the blanks are cut at a third party facility 172. From there the blanks are shipped to an automobile manufacturer 174. The auto manufacturer stamps out roof outers to which the reinforcement ring can be attached 176 and ships the roofs to the supplier 178. The moonroof supplier assembles the sunroof reinforcement assembly into the roof panel. Roofs are shipped to the sunroof supplier and therein holes are cut into the outer panels 180. At step 182 the reinforcement assemblies are assembled with the outers in the roof structure. The completed assemblies are shipped therefrom to the auto manufacturer for inclusion with the vehicle 184. In conventional sunroof reinforcement assemblies the blanks are shipped to the sunroof supplier.

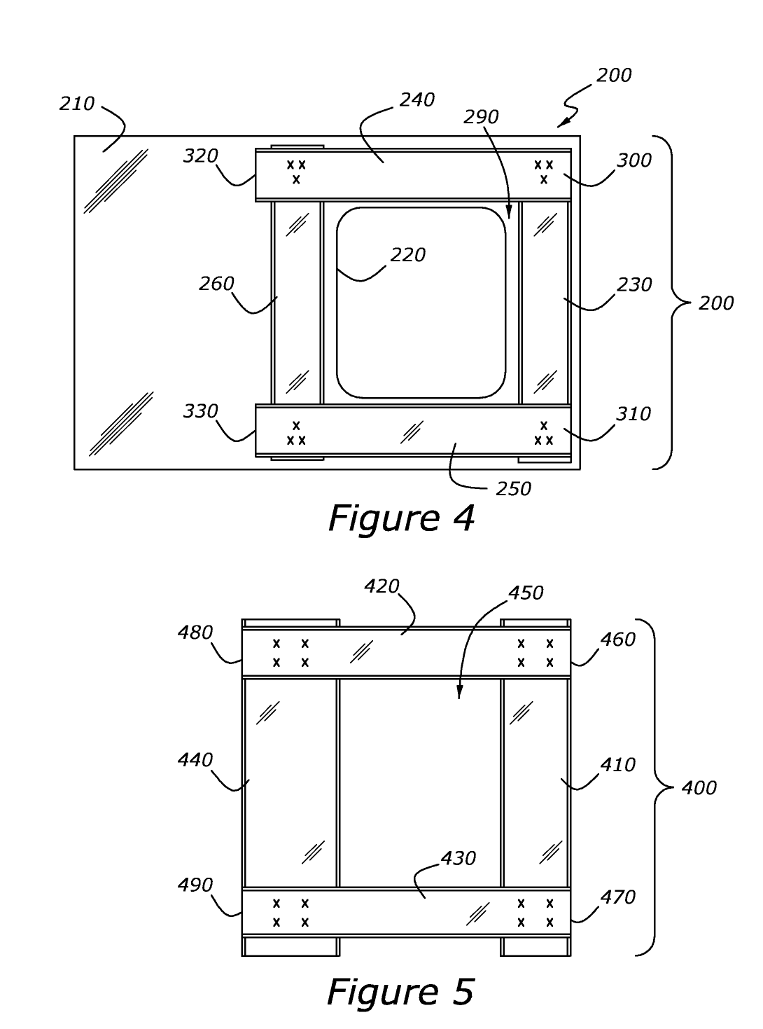

Referring now to FIG. 4, there is shown therein an improved sunroof reinforcement assembly 200. The sunroof reinforcement assembly 200 is configured to be attached to an existing roof structure 210. The roof structure 210 includes a sunroof opening 220. A sunroof or cover (e.g. 40 as shown in FIG. 1) is slidably attached to the vehicle roof structure 210.

Reinforcement assembly 200, as shown in FIG. 4, is a tailored spot-welded blank. Reinforcement assembly 200 includes several roof rails 230, 240, 250 and 260. Roof rails 230, 240, 250 and 260 are four simple rectangular blanks cut from a shear-cut-off straight from a coil sheet. A front roof rail 230 is provided. The front roof rail 230 is the roof rail closest to the front of the vehicle, e.g., 270 as shown in FIG. 1. Roof rail 230 extends across the width of a vehicle. Roof rail 230, as shown in FIG. 4, is attached to two side roof rails 240, 250 at a perpendicular angle. There is a left side roof rail 240 and a right side roof rail 250. Left roof rail 240 and right roof rail 250 are each attached at opposing ends of the front roof rail 230.

A rear roof rail 260 is also included in the sunroof reinforcement assembly 200 of FIG. 4. Rear roof rail 260 is closest to the rear of the vehicle (e.g., 280 as shown in FIG. 1). Rear roof rail 260 also extends across the width of a vehicle. Roof rail 260 is attached to the two side rails 240, 250 at a perpendicular angle. Rear roof rail 260 is attached to each of the two side rails 240, 250 at an end opposite the end in which front roof rail 230 is attached. Rear roof rail 260 is positioned perpendicularly with respect to the side roof rails 240, 250. In this embodiment, roof rails 230, 240, 250 and 260 are of a substantially similar size, shape and material composition. In the shown embodiment, roof rails 230, 240, 250 and 260 are composed of an aluminum alloy.

When attached the roof rails 230, 240, 250 and 260 define an orifice 290, as shown in FIG. 4. The orifice 290 is greater than or equal to the size of the sunroof opening 220. Rails 230, 240, 250 and 260 of the reinforcement assembly 200 encircle or outline the sunroof opening 220. In other embodiments the roof rails 230, 240, 250 and 260 define an orifice that is less than the size of the sunroof opening 220, e.g., for use with vehicles having flexible sunroofs selectively opening several areas of the vehicle cabin.

In the shown embodiment of FIG. 4, roof rails 230, 240, 250 and 260 are attached via spot welding. Roof rail 230 is spot-welded to roof rail 240 at corner 300. Roof rail 230 is spot-welded to roof rail 250 at corner 310. Roof rail 260 is spot-welded to roof rail 240 at corner 320. Roof rail 260 is spot-welded to roof rail 250 at corner 330. Each corner 300, 310, 320 and 330 of the reinforcement assembly 200 includes three spot welds (as denoted by “X”). In other embodiments, the roof rails 230, 240, 250 and 260 are affixed together by two welds and in other embodiments the roof rails are attached using only one weld at each corner junction 300, 310, 320 and 330. In this manner a ring is spot-welded together in the flat blank state. In the illustrated embodiment, roof rails 230, 240, 250 and 260 are adjoined using a spot-welded lap-joint configuration. Rails are overlapping at each corner 300, 310, 320 and 330. Rails can also be attached using fasteners such as, for example, soft piercing rivets. Clinching can also be utilized to attach the rails. In other embodiments, roof rails are adjoined using butt-joint welds, for example using a metal inert gas weld (or “MIG weld”). The MIG weld can utilize any metal such as magnesium. With butt-joint welds merging rails only need to be abutting to be affixed together. MIG welded or laser-welded lap-/butt-joints can be utilized to construct the sunroof reinforcement assembly 200 of FIG. 4.

In the shown embodiment, roof rails 230, 240, 250 and 260 are approximately 1050 mm in length, 300 mm in width (or pitch) and 1.3 mm thick. In other exemplary embodiments, rails range from 0.65 mm to 1.5 mm in thickness.

Referring now to FIG. 5, there is shown therein another sunroof reinforcement assembly 400. Reinforcement assembly 400 is a tailored spot-welded blank. The assembly 400 includes four roof rails 410, 420, 430 and 440. Roof rails 410, 420, 430 and 440 are four simple rectangular blanks cut from a shear-cut-off straight from a coil sheet. A front roof rail 410 is configured to be closest to the front of a vehicle, e.g., 270 as shown in FIG. 1. Roof rail 410 extends across the width of vehicle. Roof rail 410, as shown in FIG. 5, is attached to two side roof rails 420, 430 at a perpendicular angle. There is a left side roof rail 420 and a right side roof rail 430. Left roof rail 420 and right roof rail 430 are each attached at opposing ends of the front roof rail 410.

A rear roof rail 440 is also included in the sunroof reinforcement assembly 400 of FIG. 5. Rear roof rail 440 is configured to be closest to the rear of a vehicle, e.g., 280 as shown in FIG. 1. Rear roof rail 440, as shown in FIG. 5, also extends across the width of vehicle. Roof rail 440 is attached to the two side rails 420, 430 at a perpendicular angle. Rear roof rail 440 is attached to each of the two side rails 420, 430 at the end opposite the end in which front roof rail 410 is attached. Rear roof rail 440 is positioned perpendicularly with respect to the side roof rails 420, 430.

In the illustrated embodiment of FIG. 5, the roof rails 410, 420, 430 and 440 are tailored to be of substantially different sizes and material compositions. Side roof rails 420, 430 are smaller in size than front and rear roof rails 410 and 440, respectively. Front roof rail 410 is smaller than rear roof rail 440. Side roof rails 420, 430 are smaller in width as less structural support is required of side roof rails in this configuration. Side roof rails 420, 430 can also be composed of a different material than the other roof rails. E.g., while front and rear roof rails 410, 440 (respectively) are composed of steel, side rails 420, 430 can be composed of an aluminum alloy or vice versa. Rear roof rail 440 is the largest roof rail in this embodiment. Rear roof rail 440 provides lateral support to the C-pillar (not shown) of the vehicle, which extends between the second row of seating and rear section of the vehicle. Rear roof rail 440 is of greater material strength and can be composed of a stronger material (e.g., titanium alloys or steel). Side roof rails 420, 430 are composed of a mild steel of lower gauges for further cost savings. The gauges and grades of roof rails can be tailored to suit design requirements for different vehicles.

When attached the roof rails 410, 420, 430 and 440 define an orifice 450, as shown in FIG. 5. The orifice 450 is greater than or equal to the size of a sunroof opening. Rails 410, 420, 430 and 440 of the reinforcement assembly encircle or outline the sunroof opening. In other embodiments the roof rails 410, 420, 430 and 440 define an orifice that is less than the size of the sunroof opening, e.g., for use with vehicles having flexible sunroofs selectively opening several areas of the vehicle cabin.

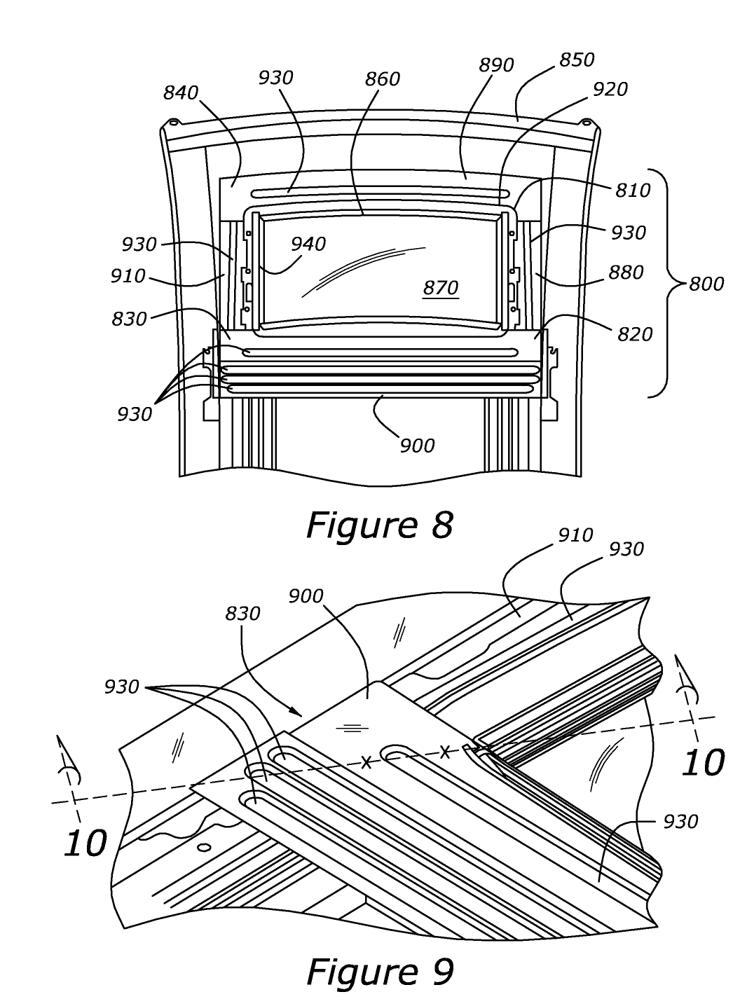

In the shown embodiment of FIG. 5, roof rails 410, 420, 430 and 440 are attached via spot welding. Roof rail 410 is spot-welded to roof rail 420 at corner 460. Roof rail 410 is spot-welded to roof rail 430 at corner 470. Roof rail 440 is spot-welded to roof rail 420 at corner 480. Roof rail 440 is spot-welded to roof rail 430 at corner 490. Each corner 460, 470, 480 and 490 of the reinforcement assembly 400 includes four spot welds (as denoted by “X”). In other embodiments, the roof rails 410, 420, 430 and 440 are affixed together by seven welds and in other embodiments the roof rails are attached using ten welds at each junction. In another embodiment, as discussed with respect to FIGS. 8-10, the corners of the reinforcement assembly can be reinforced (or “doubled up”) with additional metal to preclude higher stresses in the corners.

In the illustrated embodiment of FIG. 5, roof rails 410, 420, 430 and 440 are adjoined using a spot-welded lap-joint configuration. Rails are overlapping at each corner 460, 470, 480 and 490. Rails can also be attached using fasteners such as, for example, soft piercing rivets. Clinching can also be utilized to attach the rails. In other embodiments, roof rails are adjoined using butt-joint welds using a MIG weld. With butt-joint welds merging rails only need to be abutting to be affixed together. Spot-welded or laser-welded lap-/butt-joints can be utilized to construct the sunroof reinforcement assembly 400 of FIG. 5.

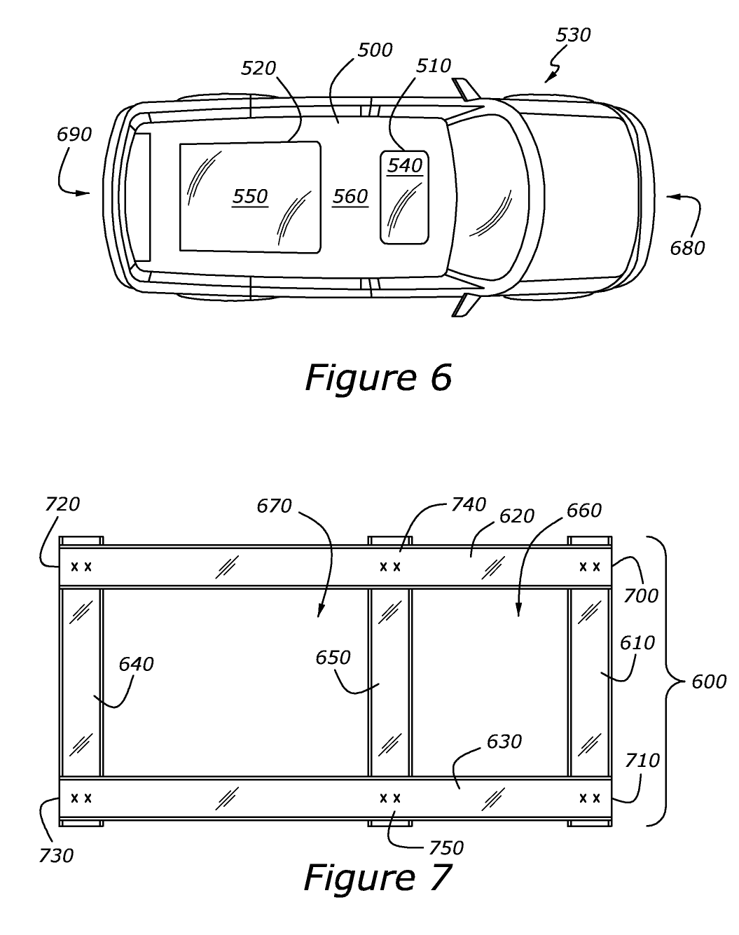

With reference now to FIG. 6, there is shown therein a top view of an exemplary vehicle roof 500 having multiple sun roofs openings 510 and 520. The shown vehicle 530 is a sports utility vehicle. Various automobiles, however, can include overhead systems with multiple sunroofs, such as for example, full-sized sedans, cross-over vehicles, sports utility vehicles and limousines. The shown vehicle 530 has an extended passenger compartment. Sunroof 540 enables light to enter a front portion of the passenger compartment—where the driver and front seat passenger may be seated; sunroof 550 enables the rearward portion of the passenger compartment to receive light. In the illustrated embodiment, sunroof 540 is substantially smaller in size than sun roof 550. In this manner, passengers in a second or third row of seating can enjoy sunlight. The roof structure 500 includes two orifices 510, 520 that correspond to the sunroofs 540, 550, respectively. Sunroofs 540, 550 comprise retractable covers that selectively close the orifices 510 and 520. Between sunroof 540 and sunroof 550 is a section of roof structure 560. This additional roof structure 560 enables additional supporting roof rails, i.e., more than four rails, to be included in the sunroof reinforcement assembly.

FIG. 7 shows a top view of an exemplary reinforcement assembly 600 configured for use with the vehicle roof 500 of FIG. 6. The assembly 600 includes five reinforcement rails 610, 620, 630, 640 and 650, thereby defining two orifices 660 and 670 that are equal to or greater in size than the orifices 510 and 520 (respectively) in roof 500 (as shown in FIG. 6). Reinforcement assembly 600 is a tailored spot-welded blank. Roof rails 610, 620, 630, 640 and 650 are five simple rectangular blanks cut from a shear-cut-off straight from a coil sheet. A front roof rail 610 is configured to be closest to the front of a vehicle, e.g., 680 as shown in FIG. 6. Roof rail 610 extends across the width of vehicle. Roof rail 610, as shown in FIG. 7, is attached to two side roof rails 620, 630 at a perpendicular angle. There is a left side roof rail 620 and a right side roof rail 630. Left roof rail 620 and right roof rail 630 are each attached at opposing ends of the front roof rail 610.

A rear roof rail 640 is also included in the sunroof reinforcement assembly of FIG. 7. Rear roof rail 640 is configured to be closest to the rear of a vehicle, e.g., 690 as shown in FIG. 6. Rear roof rail 640, as shown in FIG. 7, also extends across the width of vehicle. Roof rail 640 is attached to the two side rails 620, 630 at a perpendicular angle. Rear roof rail 640 is attached to each of the two side rails 620, 630 at the end opposite the end in which front roof rail 610 is attached.

A middle roof rail 650 is also shown in FIG. 7. Roof rail 650 extends between the side roof rails 620, 630. Rail 650 is configured to extend across the width of the vehicle, between a front portion of the passenger compartment and a rear portion of the passenger compartment, i.e., between orifice 510 and 520, underneath section 560 (as shown in FIG. 6). Roof rail 650 is attached to the two side rails 620, 630 at a perpendicular angle.

In the illustrated embodiment of FIG. 7, the roof rails 610, 620, 630, 640 and 650 are tailored to be of substantially similar material compositions. Roof rails 610, 640 and 650 are tailored to be of substantially similar sizes; Roof rails 620 and 630 are longer than rails 610, 640 and 650 and are tailored to be of substantially different sizes. Side roof rails 620, 630 can also be composed of a different material than the other roof rails. E.g., while front and rear roof rails 610, 640 (respectively) are composed of steel, side rails 620, 630 and/or middle rail 650 can be composed of titanium alloy or vice versa. Middle roof rail 650 provides lateral support to the C-pillar (not shown) of the vehicle, which extends between the second row of seating and rear section of the vehicle. The gauges and grades of roof rails 610, 620, 630, 640 and 650 can be tailored to suit design requirements for different vehicles.

When attached the roof rails 610, 620, 630, 640 and 650 define two orifices 660 and 670, as shown in FIG. 7. Orifice 660 is greater than or equal to the size of sunroof opening 510 (as shown in FIG. 6). Rails 610, 620, 630 and 650 of the reinforcement assembly 600 encircle or outline the sunroof opening 510. Orifice 670 is greater than or equal to the size of sunroof opening 520 (as shown in FIG. 6). Rails 620, 630, 640 and 650 of the reinforcement assembly 600 encircle or outline the sunroof opening 520.

In the shown embodiment of FIG. 7, roof rails 610, 620, 630, 640 and 650 are attached via spot welding. Roof rail 610 is spot-welded to roof rail 620 at corner 700. Roof rail 610 is spot-welded to roof rail 630 at corner 710. Roof rail 640 is spot-welded to roof rail 620 at corner 720. Roof rail 640 is spot-welded to roof rail 630 at corner 730. Roof rail 650 is spot-welded to roof rails 620 and 630 at a mid-section 740 and 750, respectively, of each rail. Each corner or weld area on the reinforcement assembly 600 includes two spot welds. In other embodiments, the roof rails 610, 620, 630, 640 and 650 are affixed together by one weld and in other embodiments the roof rails are attached using six welds at each junction. In another embodiment, the weld areas of the reinforcement assembly are reinforced (or “doubled up”) with additional metal to preclude higher stresses in the corners (e.g., as discussed with respect to FIGS. 8-10).

In the illustrated embodiment of FIG. 7, roof rails 610, 620, 630, 640 and 650 are adjoined using a spot-welded lap-joint configuration. Rails 610, 620, 630, 640 and 650 are overlapping at each corner 700, 710, 720 and 730 as well as at the mid-sections of rails 740 and 750. Rails can also be attached using fasteners such as, for example, soft piercing rivets. Clinching can also be utilized to attach the rails. In other embodiments, roof rails 610, 620, 630, 640 and 650 are adjoined using butt-joint welds with a MIG weld for example. With butt-joint welds merging rails only need to be abutting to be affixed together. Spot-welded or laser-welded lap-/butt-joints can be utilized to construct the sunroof reinforcement assembly 600 of FIG. 7.

Other configurations of the sunroof reinforcement assembly, having more than five supporting rails, are within the scope of the present invention. For example, some vehicles might include three or more sunroof openings. As such the sunroof reinforcement assembly can include six or more rails. Rails can also be connected with other angular relationships besides perpendicular positioning. For example, in one embodiment a rail is added between a corner of two rails and is positioned at a 45 degree angle with respect to the other two rails. Since the reinforcement assembly is a tailored blank the assembly is flexible in construction to accommodate various vehicle roofs and sunroofs.

Referring now to FIGS. 8-10 there is shown therein another exemplary sunroof reinforcement assembly 800. The weld areas 810, 820, 830 and 840 of the reinforcement assembly are reinforced (or “doubled up”) with additional reinforcement metal to preclude higher stresses in the corners. The reinforcement assembly 800 is installed in a roof structure 850. Roof structure 850 includes an orifice 860 to accommodate the sunroof 870 (shown in the extended or deployed position). The assembly 800 includes four reinforcement rails 880, 890, 900 and 910, thereby defining an orifice 920 that is equal to or greater in size than the orifice 860 in roof 850 (as shown in FIG. 8). Reinforcement assembly 800 is a tailored spot-welded blank. Roof rails 880, 890, 900 and 910 are four complex rectangular blanks cut from a shear-cut-off straight from a coil sheet. After or while being cut from the coil sheet, blanks are formed to include longitudinal beads (e.g., 930) extending from one end to the other end of the blank. For example, as shown in FIG. 9, rail 900 includes three beads 930 that extend from each end of rail 900. Beads 930 are protrusions formed in the surface of rail 900 and are configured to increase the rigidity of rail. Beads 930 are formed in each of the rails 880, 890, 900 and 910 to improve the overall structural rigidity of the sunroof reinforcement assembly 800. A roof outer 940 is inserted in the assembly to couple the roof structure 850 to the reinforcement assembly 800.

Referring again to FIG. 8, a front roof rail 890 is configured to be closest to the front of a vehicle, e.g., 270 as shown in FIG. 1. Roof rail 890 extends across the width of vehicle. Roof rail 890 is attached to two side roof rails 880 and 910 at a perpendicular angle. There is a left side roof rail 910 and a right side roof rail 880. Left roof rail 910 and right roof rail 880 are each attached at opposing ends of the front roof rail 890.

A rear roof rail 900 is also included in the sunroof reinforcement assembly 800 of FIG. 8. Rear roof rail 900 is configured to be closest to the rear of a vehicle, e.g., 280 as shown in FIG. 1. Rear roof rail 900 also extends across the width of vehicle. Roof rail 900 is attached to the two side rails 880 and 910 at a perpendicular angle. Rear roof rail 900 is attached to each of the two side rails 880 and 910 at the end opposite the end in which front roof rail 890 is attached.

In the illustrated embodiment of FIGS. 8-10, the roof rails 880, 890, 900 and 910 are tailored to be of substantially similar sizes and material compositions. Side roof rails 880 and 910 can also be composed of a different material than the other roof rails 890 and 900. E.g., while front and rear roof rails 890 and 900 (respectively) are composed of steel, side rails 880 and 910 can be composed of titanium alloy or vice versa. Roof rail 900 provides lateral support to the C-pillar (not shown) of the vehicle, which extends between the second row of seating and rear section of the vehicle. The gauges and grades of roof rails 880, 890, 900 and 910 can be tailored to suit design requirements for different vehicles.

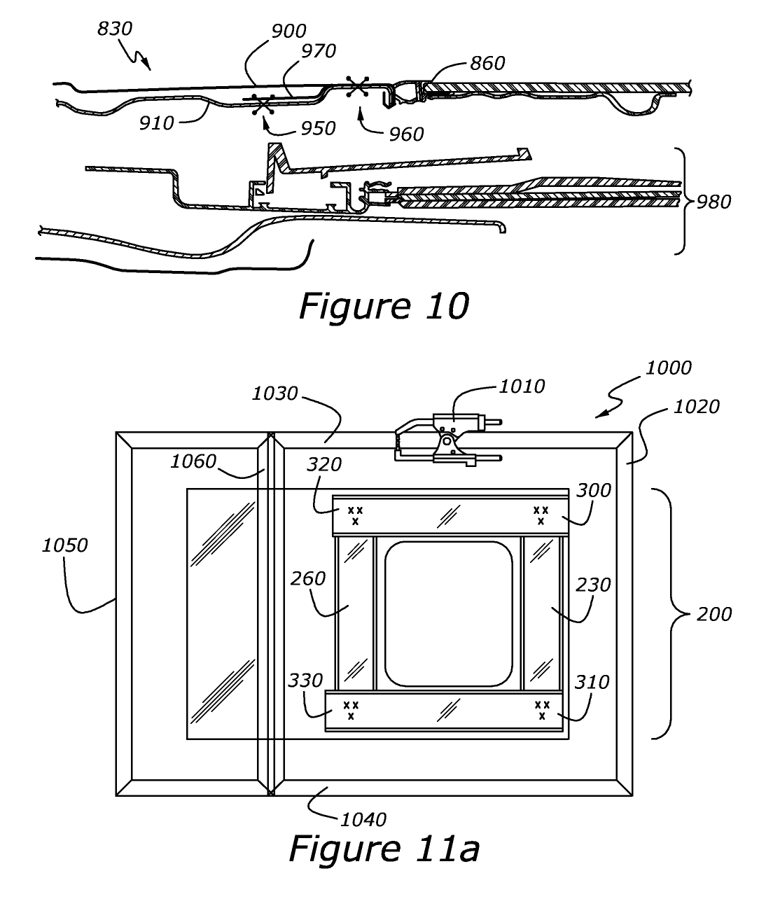

In the shown embodiment of FIG. 10, roof rails 900 and 910 are attached via spot welding. Roof rail 900 is spot-welded to roof rail 910 at corner 830. Each weld area on the reinforcement assembly 800 includes two spot welds (as denoted by “X”), as shown in FIG. 10. A first weld is applied at 950. A second weld is applied at 960 which is closer to orifice 860 in the roof 850. Welds are approximately aligned on the hypotenuse of the right angle formed by the intersection or junction of rails 900 and 910. In the embodiment disclosed in FIG. 10 there is shown therein the reinforcement assembly which is reinforced (or “doubled up”) with additional reinforcement metal to preclude higher stresses in the corners. A reinforcement material 970 is spot-welded at a corner of rails 900 and 910. The reinforcement material is a square blank having a smaller cross-sectional area than the corner 830 formed by the intersection of rails 900 and 910. Reinforcement material 970 can be of the same or different material composition than rails 900 and 910. Weld settings can be adjusted to accommodate the reinforcement material 970 placed between the rails 900 and 910. Below the welds is an overhead console system 980 that is implemented in the roof structure 850 post welding.

In the illustrated embodiment of FIG. 10, roof rails 900 and 910 are adjoined using a spot-welded lap-joint configuration. Rails 900 and 910 are overlapping at corner 830. In other embodiments, roof rails are adjoined using butt-joint welds. Rails can also be attached using fasteners such as, for example, soft piercing rivets. Clinching can also be utilized to attach the rails.

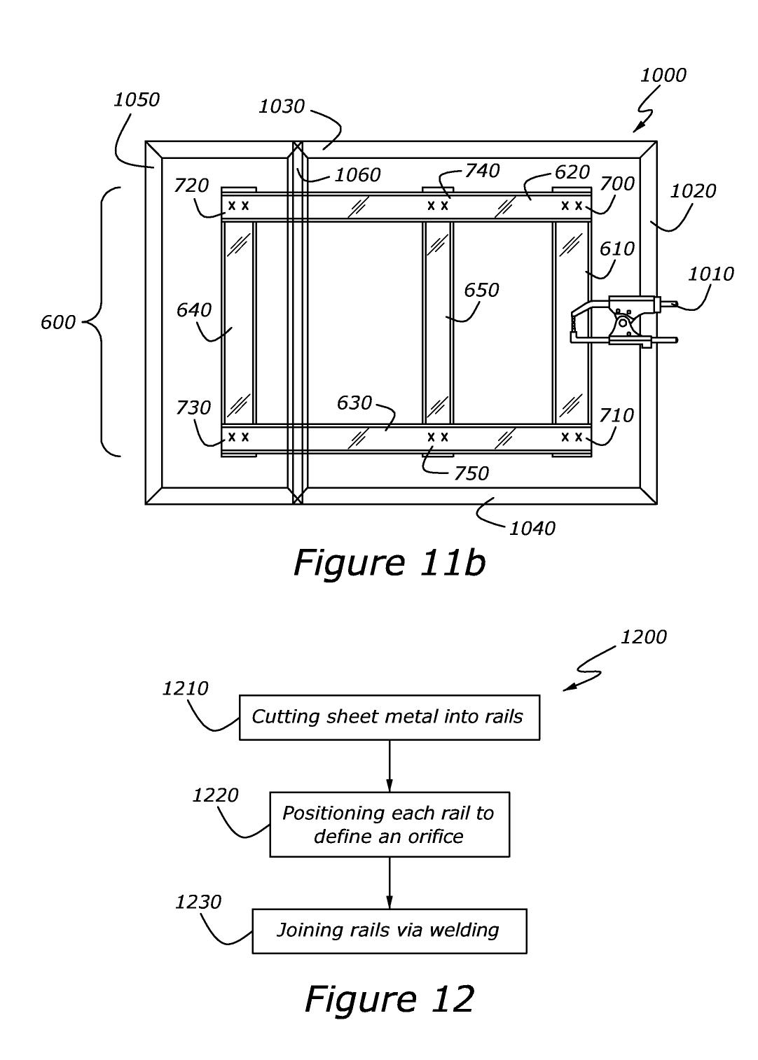

Referring now to FIGS. 11a-b there is shown a welding device 1000 suitable for the manufacture of some of the exemplary sunroof reinforcement assemblies illustrated herein. The reinforcement assemblies disclosed herein can be welding using the flexible welding fixture 1000. For example, one method of manufacture includes a welding assembly with at least one weld gun configured to slide with respect to the blank(s). Weld guns are placed on a set of rails or guides. Roof rails are clamped into place before welding. The weld fixture can accommodate weld guns of different sizes and lengths. Weld fixture can also be used to construct reinforcement assemblies of various sizes and configurations. Welding can be done just prior to stamping, as an end-item procedure at a moonroof assembly facility.

FIG. 11a is a top view of a welding device 1000 for use with an exemplary sunroof reinforcement assembly—the assembly of FIG. 4. The welding device 1000 includes a welding apparatus 1010 such as a weld gun, configured to slide with respect to the sunroof reinforcement assembly, e.g., 200. Welding apparatus 1010 sits on a set of guides having at least five guide rails 1020, 1030, 1040, 1050 and 1060. The same welding apparatus can be used for each weld on the assembly, e.g., 200 and 600 (as shown in FIG. 11b). The front guide 1020 enables welding apparatus 1010 to reach the corner weld areas 300 and 310 for the front rail 230. An intermediate guide 1060 is included to enable the welding apparatus 1010 to reach each of the corner weld areas 320 and 330 on the rear rail 260.

Welding apparatus 1010 is flexible to construct sunroof reinforcement assemblies of different construction as well. For example, FIG. 11b is a top view of the welding device 1000 of FIG. 11a configured for use with another exemplary sunroof reinforcement assembly—the assembly 600 of FIG. 7. Welding apparatus 1010 sits on a set of guides having at least five guide rails 1020, 1030, 1040, 1050 and 1060. The same weld apparatus 1010 can be used for each weld on the assembly. The front guide 1020 enables welding apparatus 1010 to reach the corner weld areas 700 and 710 for the front rail 610. An intermediate guide 1060 is included to enable the welding apparatus 1010 reach each of the weld areas 740 and 750 on the middle rail 650. A rear guide 1050 enables the weld gun 1010 to reach the corner weld areas 720 and 730 of the rear rail 640.

The tailor-welded blanks are preferably constructed using spot welding techniques. In one embodiment, the roof rails are composed of aluminum and a weld setting of 75 kilovolt-amperes (KVAs) is utilized to attach the rails. In another embodiment welds of 150 KVAs are utilized to attach the roof rails. Though the illustrated embodiments related to welding using single phase welds, multiple-phase welding can be utilized.

Referring now to FIG. 12, there is more detail on a method 1200 of manufacturing a reinforcement assembly for a vehicle sunroof. The method includes the steps of cutting a sheet of metal into at least four rails 1210; positioning each of the rails to define an orifice greater than or equal to the size of a sunroof opening 1220; and fixedly attaching the rails via spot welding 1230. A coil sheet of metal can be provided to construct the reinforcement assembly. The sheet can be cut along a width of the sheet to partition roof rails. Each roof rail can be of the same or different widths. The rails are then positioned at their respective locations and spot welded together. Using these techniques, no blank-die is required. Rails use a shear-cut-off straight from the coil sheet. This can be done at a stamping facility to prevent the need for laser-welded blanks. In some embodiments the material utilization approaches 90%. Accordingly, there is no scrap-buy-back required.

Reinforcement assemblies are tailored spot-welded blanks. The blanks are tailored in the sense that the blanks are tunable according to design specifications and cost considerations. The reinforcement assembly is no longer necessarily composed of a uniform material. Each roof rail can be of a different size, material composition or shape. Moreover, though the illustrated embodiments show four roof rails there are other embodiments of the present invention that include more and less than four rails for the reinforcement assembly. In one arrangement five rails are used. The sunroof extends across the C-pillar and can open from either the front or rear of the C-pillar. In another arrangement seven rails are used. The reinforcement assembly can be tailored to meet design requirements. In this way, the present reinforcement assemblies provide greater flexibility than the conventional form cut reinforcement rings.

The exemplary rails illustrated herein are rectangular sheets or strips of metal. Rails can be of other configurations and material selections. For example, rails can be formed as tubular members, in an I-beam configuration, or in a C-beam configuration. Rails can be any kind of reinforcement member and can be composed of various different metals such as, e.g., aluminum or titanium alloys. Hard plastics or other composite materials, for example, can also be used to construct rails. In other embodiments, rails are not composed of solid materials and include orifices to reduce weight. Rails need not have a smooth surface but can include ridges formed therein (for example) to alter the performance of the rails.

Spot welding is the preferred method of attaching roof rails for the reinforcement assembly. Spot welding is generally much less expensive than laser welding. Though spot welding is the preferred method of attachment, roof rails can be attached using other attachment mechanisms known in the art. For example, roof rails can be laser welded together, press fit, glued, riveted, or screwed together.

The various exemplary embodiments provide sunroof reinforcement assemblies and methods for manufacturing the same. Some embodiments of the present invention can be used in automobiles of various types including those with larger sunroofs, e.g., limousines and busses.

It will be apparent to those skilled in the art that various modifications and variations can be made to the methodologies of the present disclosure without departing from the scope of its teachings. Other embodiments of the invention will be apparent to those skilled in the art from consideration of the specification and practice of the teachings disclosed herein. It is intended that the specification and examples be considered as exemplary only. While the best modes for carrying out the invention have been described in detail, those familiar with the art to which this invention relates will recognize various alternative designs and embodiments for practicing the invention.

We claim:

1. A method of manufacturing a reinforcement assembly for a vehicle sunroof, the method comprising:
cutting a sheet of metal along into at least four rails;
positioning each of the rails to define an orifice greater than or equal to the size of a sunroof opening; and
fixedly attaching the rails using a lap-joint configuration.

2. The method of claim 1, wherein the fixedly attaching of the rails is done via spot welding.

3. The method of claim 2, further comprising:
placing reinforcement metal at a corner of at least one rail; and
fixedly attaching the reinforcement metal at the corner.

4. The method of claim 3, wherein the fixedly attaching the reinforcement metal includes spot-welding the reinforcement metal at the corner.

5. The method of claim 1, wherein the fixedly attaching of the rails is done via laser welding.

6. The method of claim 1, further comprising:
fixedly attaching a fifth roof rail between two of the at least four rail.

7. The method of claim 1, wherein the cutting of the sheet metal includes cutting rails to be of a substantially similar width, gauges and/or lengths.

8. The method of claim 1, wherein the cutting of the sheet metal includes cutting rails to be of substantially different widths, gauges and/or lengths.

9. The method of claim 1, further comprising:
placing at least one weld gun on a set of guides, the weld gun configured to slide with respect to the four rails; and
applying welds to rails with the weld gun.

10. A vehicle roof structure having a sunroof, the roof structure comprising:
a reinforcement assembly including:
a first rail attached to a second rail and a third rail in a lap-joint configuration; and
a fourth rail attached to the second rail and the third rail in a lap-joint configuration;
wherein the reinforcement assembly defines an orifice that is greater than or equal to the size of a sunroof opening.

11. The vehicle roof structure of claim 10, wherein the at least one of the first rail, second rail, third rail or fourth rail is a shear-cut off from a coil sheet.

12. The vehicle roof structure of claim 10, wherein at least one of the first rail, second rail, third rail or fourth rail is of a substantially different width, gauge and/or length than at least one of the other first rail, second rail, third rail or fourth rail.

13. The vehicle roof structure of claim 10, wherein at least one of the first rail, second rail, third rail or fourth rail is of a substantially similar width, gauge and/or length than at least one of the other first rail, second rail, third rail or fourth rail.

14. The vehicle roof structure of claim 10, wherein at least one of the first rail, second rail, third rail or fourth rail is of a substantially different material compositions than at least one of the other first rail, second rail, third rail or fourth rail.

15. The vehicle roof structure of claim 10, wherein the first rail is spot-welded to a second rail at a corner of the second rail; and wherein the fourth rail is spot-welded to the second rail at another corner of the second rail.

16. The vehicle roof structure of claim 15, wherein at least two of the first rail, second rail, third rail or fourth rail are spot-welded.

17. The vehicle of claim 10, wherein the first rail is spot-welded to the second rail using at least two welds.

18. The vehicle of claim 17, wherein the first rail is spot-welded to the second rail using at least three welds.

19. The vehicle of claim 18, wherein the first rail is spot-welded to the second rail using at least four welds.

20. The vehicle roof structure of claim 10, further comprising:
a reinforcement material, spot-welded at a corner of at least two of the first rail, second rail, third rail or fourth rail.

21. The vehicle roof structure of claim 10, further comprising:
a fifth roof rail between the second roof rail and the third roof rail.
